(19) United States
(12) Patent Application Publication
(10) Pub. No.: US 2015/0188982 A1
(43) Pub. Date: Jul. 2, 2015

(54) METHOD AND APPARATUS FOR REMOTE CONTROL OF DEVICES OVER NETWORK

(71) Applicant: SEENATH PUNNAKKAL, FORT WORTH, TX (US)

(72) Inventor: SEENATH PUNNAKKAL, FORT WORTH, TX (US)

(21) Appl. No.: 14/140,535

(22) Filed: Dec. 26, 2013

(51) Int. Cl. H04L 29/08

(52) U.S. Cl. CPC H04L 67/025

(57) ABSTRACT

The invention is a way to remote control apparatuses over internet in a cost effective and easy manner so that it is easy for non-technical users to setup and use. The method uses, a mobile computer, such as a contemporary ‘smart-phone’, with wireless internet connection and an audio port to control apparatuses and also allows local and remote operators, if manned, to exchange text, voice and video modes of communication as well.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The invention presented here relates to the use of mobile computers such as contemporary smart-phones in enabling low cost and easily configurable so called ‘Internet-Of-Things’ (IOT), where such devices are connected to the internet and can be controlled or contacted from the internet or send data to other devices or servers on the internet. Typical IOT's have their own unique address and own internet connection capability through wireless network. This involves a lot of power requirement, hardware and software requirement and often involves custom software development at a lower level. The invention presented here takes advantage of wireless connections in a contemporary smart-phone and enables other devices to connect to the internet in a low power, cheap and setup free way using the smart-phone connection.

### BACKGROUND OF THE INVENTION

Prior art, Chinese Patent CN203025788 U describes a IOT laboratory attendance system, a typical IOT device. This ‘Internet-Of-Things’ (IOT) device connects to the internet using a GSM module setup with SIM card and data plan and other sub components of the system connecting to the main system with Wifi and Zigbee connections to collect the data from terminals.

### BRIEF SUMMARY OF THE INVENTION

The present invention uses minimal user setup other than connecting the audio cable from the device to be controlled over the network, to a mobile computer, such as a contemporary smart-phone, with internet connection. This easy setup eliminates the steps in getting and maintaining a GSM SIM card and expensive and recurring cost data connection to the internet and the additional cost and power needed by the device due to the presence of a GSM radio in it. This is even more trouble if the internet connection needed is of a temporary nature such as needed during an installation or repair process such as the installation of wiring in a building.

If the device uses very low or bursts of power, then the present invention can power the device from the audio cable connection of the mobile smart-phone.

### BRIEF DESCRIPTION OF THE SEVERAL VIEWS OF THE DRAWING

FIG. 1 is a pictorial representation of one of the preferred embodiment of the present invention in the form of an irrigation valve and wiring tester 150. 100 is a mobile computer or laptop connected to the same network 120 as the mobile computer 105 which directly controls the tester 150. Network connect is wireless 110 as shown in FIG. 1. Mobile computer 105 is connected to the tester 150 using audio cable 140, with one connector 133 plugged into the mobile computer 105 and the other connector 130 connected to the tester 150 input. The tester circuits are powered by power supply 260 which derives its power from 24 VAC from connector terminal 200 connectors 230 and 240, which are connected to wiring of the system under test. Valves wires from different zones of the irrigation system under test are connected to connectors R1 (250), R2, R3 and R4. When the relay 210 is activated zone connected to R1 gets energized and sprinkles water in that zone which the tester user can verify. The CPU 270 and non-volatile memory 360 ensure the tester is programmable and remembers the states in case of power failure. The CPU also accepts commands from the mobile computer 105 through the signal conditioner and signal decoder/encoder 220. The CPU can also send back responses or data through the signal conditioner and encoder 220 to the mobile computer 105 to handle.

FIG. 2 is a pictorial representation of one of the preferred embodiment of the present invention in the form of a multi port tone generator 150. 100 is a mobile computer or laptop connected to the same network 120 as the mobile computer 105 which directly controls the tone generator 150. Network connect is wireless 110 as shown in FIG. 1. Mobile computer 105 is connected to the tone generator 150 using audio cable 140, with one connector 133 plugged into the mobile computer 105 and the other connector 130 connected to the tone generator 150 input. The tone generator circuits is powered by power supply 330. The CPU 350 and non-volatile memory 360 ensure the tone generator is programmable and remembers the states in case of power failure. The CPU also accepts commands from the mobile computer 105 through the signal conditioner and signal decoder/encoder 220. The CPU can also send back responses or data through the signal conditioner and encoder 220 to the mobile computer 105 to handle. Tone signal conditioner 320 ensures the signals have the required amplitude, impedance and balance. Multiplexer 340 selects port to put out signal to. The output ports should handle over-voltage and ESD events, protector 310 handles those duties. The available output ports are 301, 302, 303 and 304.

FIG. 3 is a pictorial representation of an embodiment where there are multiple control computers 100 are connected to the same network 120 and devices under control 150 connected to the respective smart-phones 105 using respective audio cables 140 between respective ports 133 and 130 Mobile computer 105 is connected to the tone generator 150 using audio cable 140 , with one connector 133 plugged into the mobile computer 105 and the other connector 130 connected to 150. The CPU can also send back responses or data to the mobile computer 105 to handle.

### DETAILED DESCRIPTION OF THE INVENTION

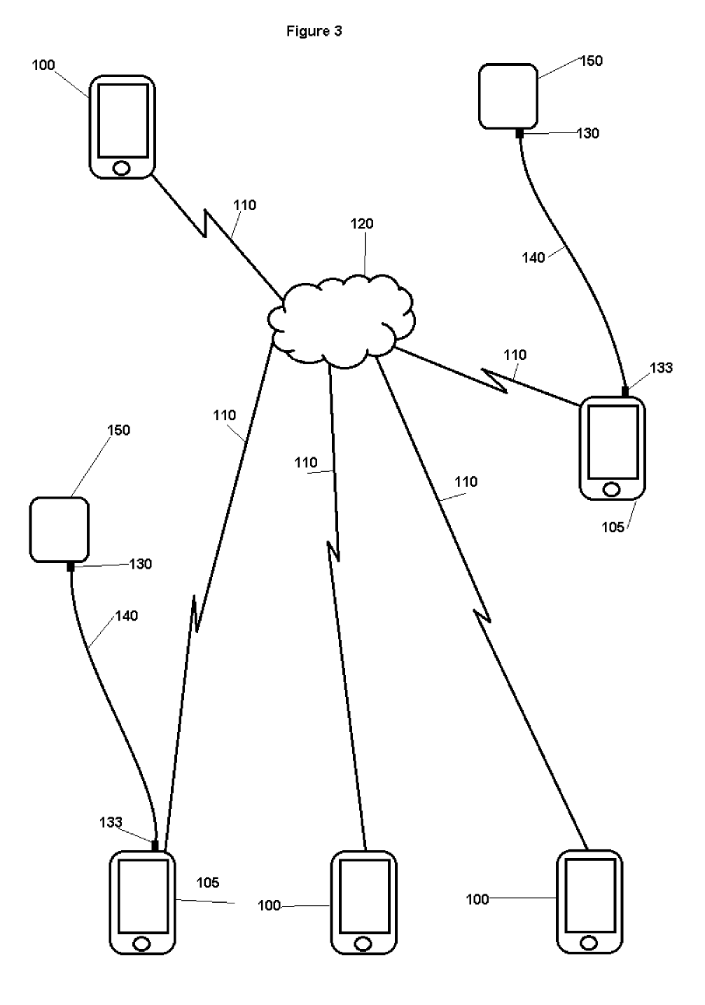

The FIG. 3 shows one embodiment of the present invention. It shows multiple remote computers 100 connected to a network 120 that may be private or public like the internet or a combination of both. The local mobile computers 105 such as contemporary smart-phones are also connected to the network through GSM or WiFi or other wired or wireless connections. The local mobile computers are also connected to the device under control 150 through the audio port connectors 133, 130 and cable 140. Inside the device there is an apparatus that conditions the audio signals in and out and also encodes and decodes the data in a scheme like frequency shift keying (FSK) or other similar schemes known to practitioners of the art. The local computers 105 have software in it that can encode command or information to be send to the device 150 and receive and decode information coming back from the device 150. The software in the local computer 105 also has ability to send and receive communication from other computers, servers and devices on the network. This allows the remote computers 100 to control the devices 150 through an intermediary mobile computer 105, which essentially makes the device 150 a network controlled device, though the device 150 by itself lacks resources for wireless or network protocols or software or power supply to handle those activities. This also makes the device 150 cheaper to connect to the network. Also note that one device may be controlled from multiple devices and each mobile computer 105 can communicate with other devices through their respective mobile computers.

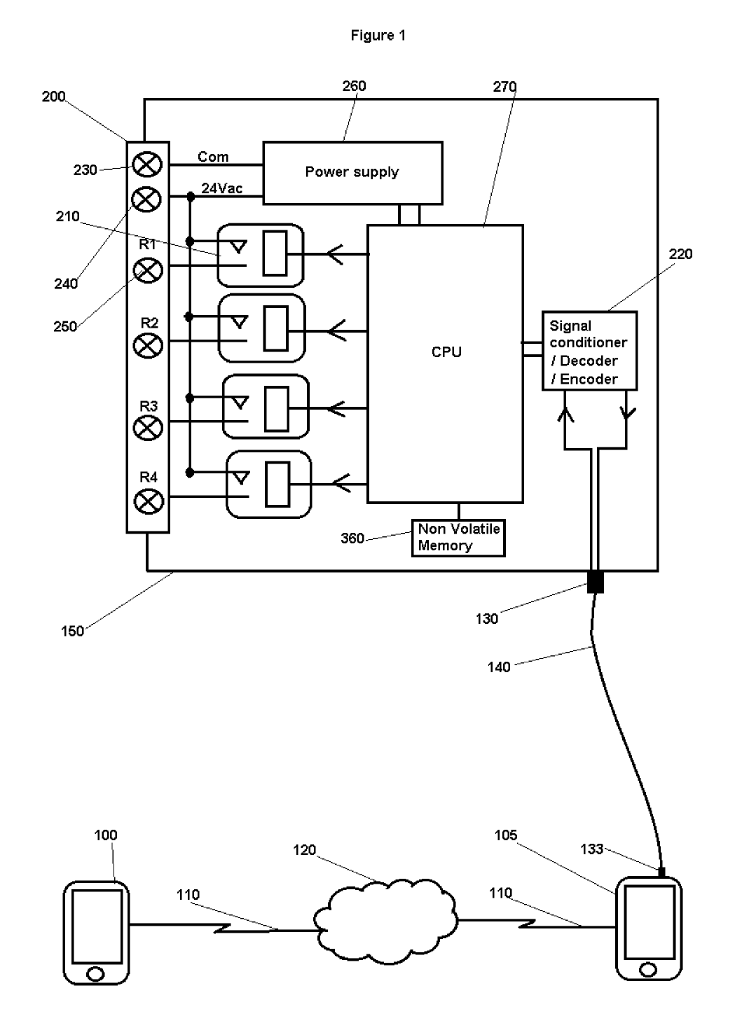

The FIG. 1 shows one embodiment of the present invention. It is a simpler configuration. Here the remote computer 100 connects to mobile computer 105 through the network 120 and their respective wireless 110 connections. This embodiment is an irrigation tester that allows the testing of irrigation valves and wiring. The system can be connected to a wired irrigation system and user can use software on mobile computer 105 to locally turn on valves as needed to check out the sprinkler system zones. Sometimes it is easier to connect the mobile devices 105 and 100 to the network using WiFi or internet using GSM. The software on computer 100 allows the user to detect and connect to mobile computer 105 and turn on sprinkler valves remotely from computer 100 from far away from the tester box 150. Practitioner of the art may also notice that the configuration can be used as an irrigation controller. That would allow the controller to be controlled easily from smart-phone 105. The controller can be cheaper without an LCD and keyboard. The software allows easier programming than from a typical irrigation controller user interface.

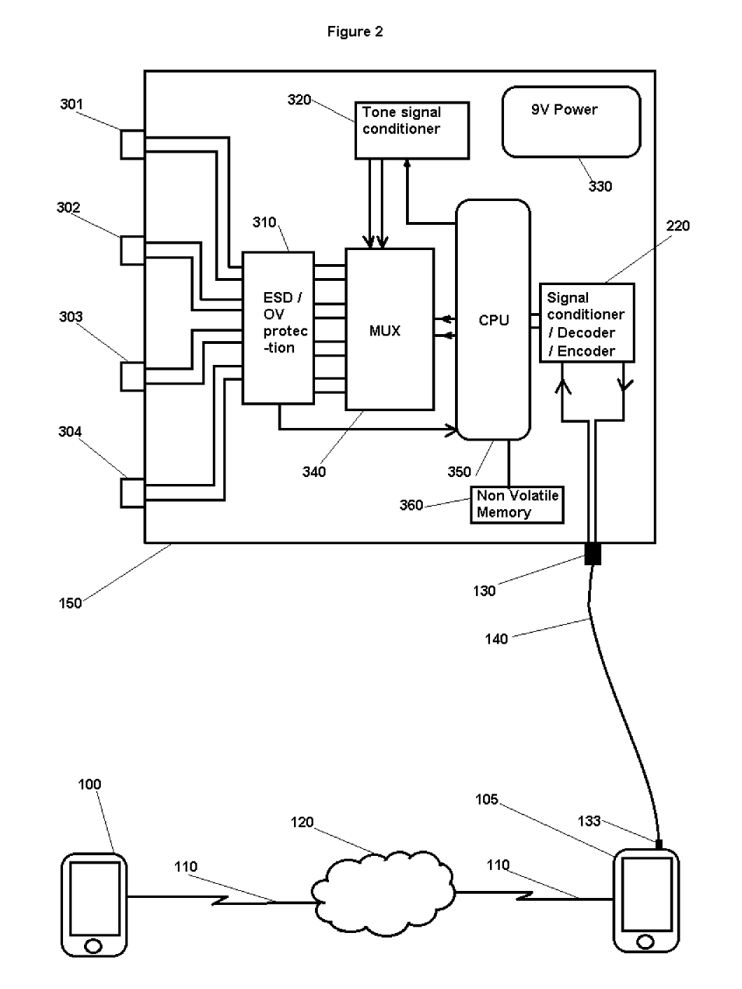

The FIG. 2 shows one embodiment of the present invention. It is a tone generator. A tone generator is typically connected to the far end of a cable plant and turned on. It produces a fixed tone on a wire or wire pair. The user can then go to the near end of the cable and try to pick up signal from the tone with a separate tone detector device. Thus wires can be identified and tagged. With a typical tone generator the user has to walk back and forth to connect to different wire pairs and trace that individually. The system of FIG. 2 operates very similar to system in FIG. 1. The user can connect remotely from 100 and switch the tone to a different wire pair when needed or even change tone frequency if some unknown common mode tone interferes with the initial tone frequency.

The invention claimed is:

1. A method of controlling and communicating bi-directionally with a device over public or private network using a mobile computer connected to the said device, from a second computer connected over the said network and an apparatus connecting the mobile computer to the said device. The mobile computer comprising;
at least one audio input;
at least one audio output port;
a wireless or wired network connection to the said network;
software that sends out encoded audio signals and receives and decodes audio signals. The said software can also send and receive data to and from said other devices on the network.
the apparatus comprising;
a decoder in the said device connected to audio input;
an encoder in the said device connected to audio output;
a non-volatile memory to remember the states in the device under control;
and the method comprising the steps of;
the said second computer sends a communication intended for the said device to the said mobile computer connected to the said device;
the said mobile computer encodes the said communication into audio signal sent to the said apparatus in the said device;
the said apparatus in the said device decodes the signal and translates it into action for the said device;
the said device sends back return communication to the encoder in the said apparatus which converts it to audio signal;
the audio signal is received by the said mobile computer and converted and sent as return communication for the said second computer.

2. The said apparatus of claim 1 is a second general purpose control device outside of the said device of claim 1.

3. The said apparatus of claim 1 is built into the said device of claim 1.

4. The said second computer of claim 1 is a server.

5. The said second computer of claim 1 is another mobile computer.

6. The encoder and decoder of claim 1 uses phase shift keying for audio signal communications with said mobile computer.

7. The encoder and decoder of claim 1 uses frequency shift keying for audio signal communications with the said mobile computer.

8. The encoder and decoder of claim 1 uses amplitude shift keying for audio signal communications with the said mobile computer.

9. The encoder and decoder of claim 1 uses quadrature amplitude shift keying for audio signal communications with the said mobile computer.

10. The encoder and decoder of claim 1 uses amplitude modulation for audio signal communications with the said mobile computer.

11. Method of direct control of the said device of claim 1 from the said mobile computer without the need for the said second computer, wherein rest of the methods are same as those in claim 1.

12. Method and apparatus for testing wire physical layer parameters for cables used in irrigation, security, electrical and network wiring using the method and apparatus of claim 1, comprising;
the method and apparatus of claim 1;
wire tester connected to the said apparatus and;
relays and multiplexers to switch tester ports to multiple wire pairs.
